(19) United States
(12) Patent Application Publication
(10) Pub. No.: US 2010/0047678 A1
(43) Pub. Date: Feb. 25, 2010

(54) BATTERY FIXING MECHANISM

(75) Inventor: WEN-TA CHUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/423,080

(22) Filed: Apr. 14, 2009

(30) Foreign Application Priority Data
Aug. 20, 2008 (CN) 200810304114.X

(51) Int. Cl. H01M 2/10

(52) U.S. Cl. 429/100

(57) ABSTRACT

A battery fixing mechanism includes a main body and an elastic positioning member. The main body defines an assembling groove configured for partly receiving a battery. The elastic positioning member extends from the main body. The elastic positioning member has a restricting portion. The restricting portion is opposite to the assembling groove. The elastic positioning member is capable of bending so that the battery can be inserted into the assembling groove of the main body.

### BACKGROUND

1. Technical Field

The present disclosure relates generally to battery fixing mechanisms and, more particularly, to a battery fixing mechanism for an electronic device.

2. Description of Related Art

Electronic devices, such as computers and mobile phones, are widely used in modern society. The electronic devices generally have internal batteries to supply electricity. The batteries are held in the electronic devices via battery fixing mechanisms to prevent the internal batteries from disengaging from the electronic devices.

A typical battery fixing mechanism includes a base, a cover, two connecting members, and two screws. The base defines an assembling groove. Two connecting members are fixed on opposite sides of the base. An end of a battery is received in the assembling groove of the base. The cover is disposed on the other end of the battery, and the connecting members are fixed to the cover via the screws.

However, if the battery needs to be removed or replaced, the screws need to be loosened to remove the cover. After the battery is removed or replaced, the cover must be put back and the screws reattached. Therefore, a process of assembling and disassembling the battery to the battery fixing mechanism is complex and tedious.

Therefore, a battery fixing mechanism which overcomes the above-described shortcomings is desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded, isometric view of a first embodiment of a battery fixing mechanism and a battery to be assembled in the battery fixing mechanism.

FIG. 2 is an assembled, isometric view of the battery fixing mechanism and the battery of FIG. 1.

FIG. 3 is a side cross-sectional view of the battery fixing mechanism and the battery of FIG. 2, taken along line III-III thereof.

FIG. 4 is an exploded, isometric view of a second embodiment of a battery fixing mechanism and a battery to be assembled to the battery fixing mechanism.

FIG. 5 is an assembled, isometric view of the battery fixing mechanism and the battery of FIG. 4.

FIG. 6 is a side cross-sectional view of the battery fixing mechanism and the battery of FIG. 5, taken along line VI-VI thereof.

FIG. 7 is an exploded, isometric view of a third embodiment of an battery fixing mechanism and a battery to be assembled to the battery fixing mechanism.

FIG. 8 is an assembled, isometric view of the battery fixing mechanism and the battery of FIG. 7.

FIG. 9 is a side cross-sectional view of the battery fixing mechanism and the battery of FIG. 8, taken along line IX-IX thereof.

### DETAILED DESCRIPTION

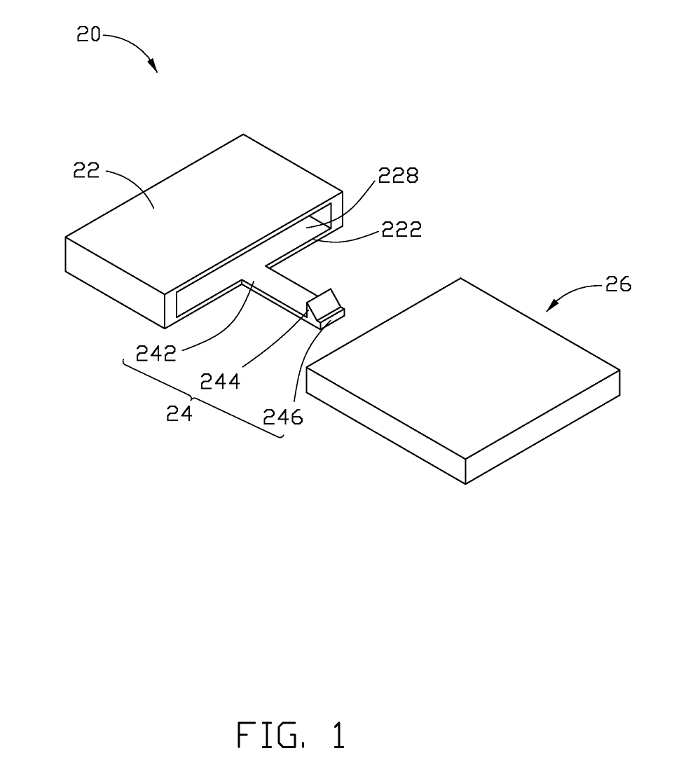

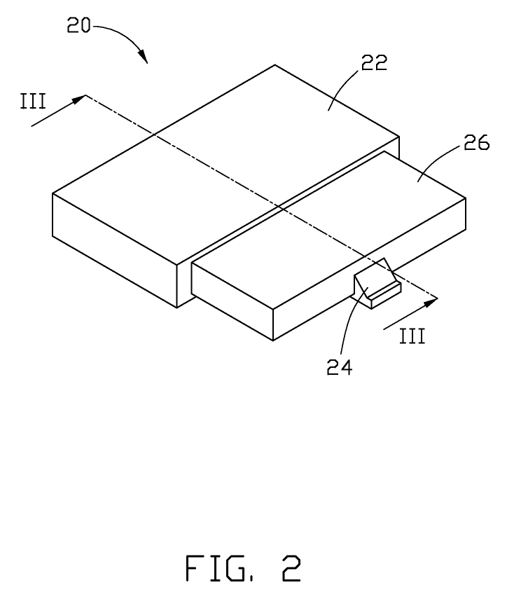

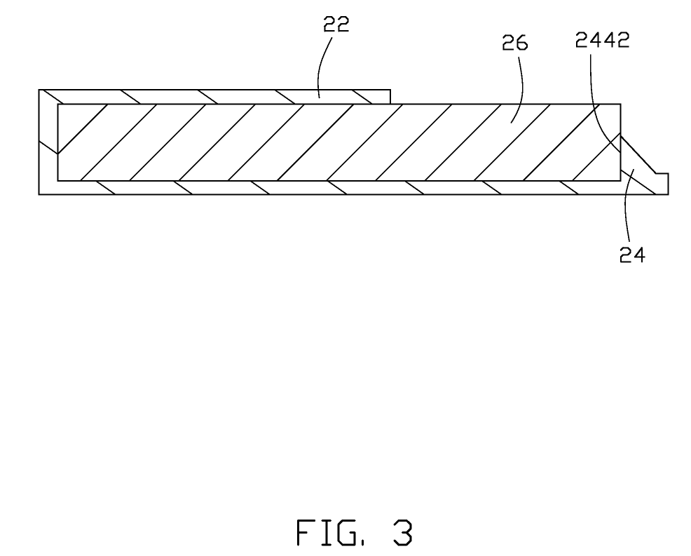

Referring to FIGS. 1 through 3, a first embodiment of a battery fixing mechanism 20 includes a main body 22 and an elastic positioning member 24 extending from an end of the main body 22. The battery fixing mechanism 20 is configured for fixedly receiving a battery 26. In the illustrated embodiment, the battery 26 is rectangular shaped.

The main body 22 defines an assembling groove 228 in a side surface 222. The assembling groove 228 has an opening facing the elastic positioning member 24 and has a shape corresponding to the battery 26. In the illustrated embodiment, the main body 22 is rectangular shaped and the assembling groove 228 is a rectangular groove. The elastic positioning member 24 includes an elastic portion 242, a restricting portion 244, and an operating portion 246. The elastic portion 242 extends from the main body 22. The restricting portion 244 extends substantially perpendicularly from an end of the elastic portion 242 away from the main body 22 opposite to the assembling groove 228. The restricting portion 244 has a flat resisting surface 2442 corresponding to a shape of the battery 26. The operating portion 246 is formed on an end of the restricting portion 244 away from the elastic portion 242. In the illustrated embodiment, the elastic portion 242 is a flat piece. The elastic portion 242 may be made of metal or plastic.

In assembling the battery 26 into the main body 22, the operating portion 246 is pressed by an external force, causing the elastic portion 242 to bend so that the battery 26 can be received in the assembling groove 228, producing an elastic force. The battery 26 is inserted into the assembling groove 228 of the main body 22. The external force is released, and the elastic portion 242 restores to a free state. The restricting portion 244 resists the battery 26, thus firmly positioning the battery 26 in the assembling groove 228 of the main body 22. In disassembling the battery 26 out of the main body 22, the operating portion 246 is pressed by the external force, causing the elastic portion 242 to bend, so that the battery 26 can be removed from the assembling groove 228. At the same time, the battery 26 is taken out of the assembling groove 228 of the main body 22. Therefore, the battery fixing mechanism 20 has a simple structure, and is easy to assemble or disassemble the battery 26 from the assembling groove 228.

It should be pointed out that the assembling groove 228 of the main body 22 may receive two or more batteries 26. In that case, the battery fixing mechanism 20 would have a wider elastic positioning member 24 or more than two elastic positioning members 24 extending from the main body 22.

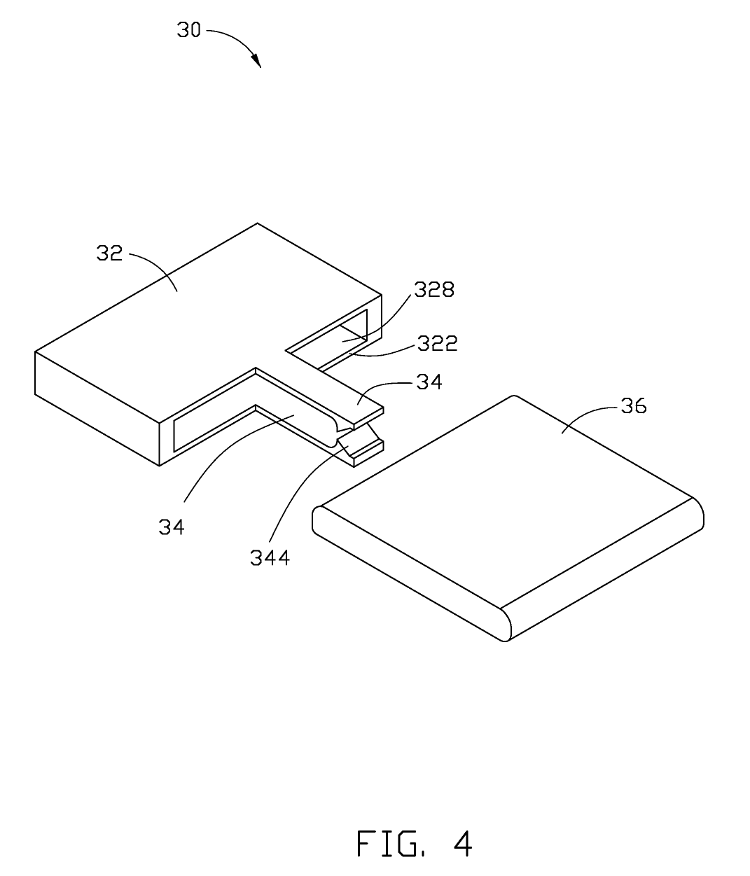

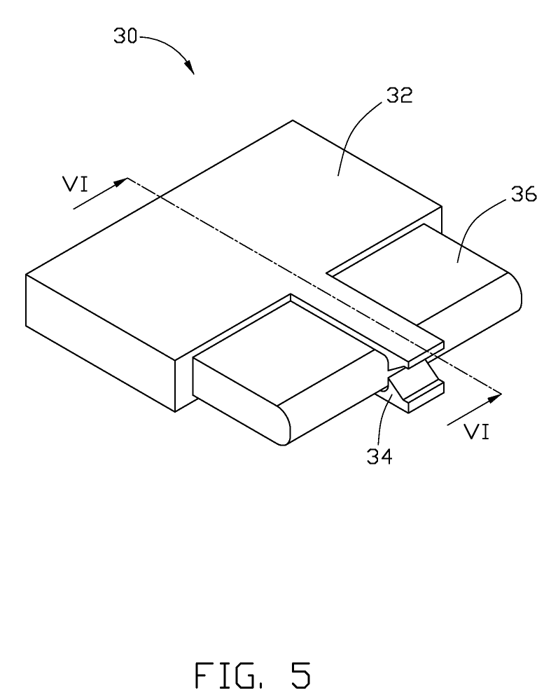

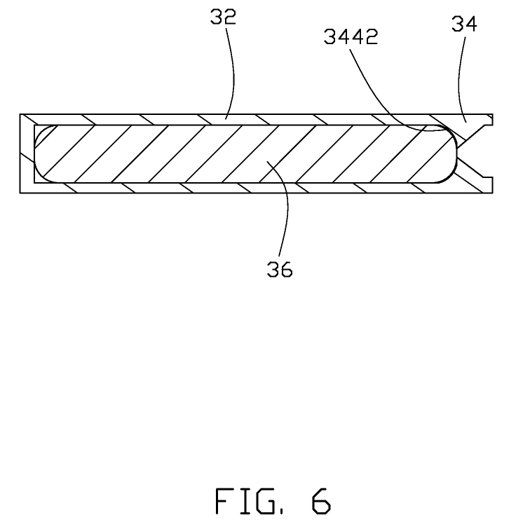

Referring to FIGS. 4 through 6, a second embodiment of a battery fixing mechanism 30 is similar to the first embodiment of the battery fixing mechanism 20, except that two elastic positioning members 34 are formed on opposite sides of a side surface 322 of a main body 32. The main body 32 defines an assembling groove 328 in the side surface 322 between the elastic positioning members 34. A restricting portion 344 of each elastic positioning member 34 may have an arched resisting surface 3442 corresponding to a shape of the battery 36. When the battery 36 is received in the assembling groove 328 of the main body 32, the elastic positioning members 34 resist opposite surfaces of the battery 36.

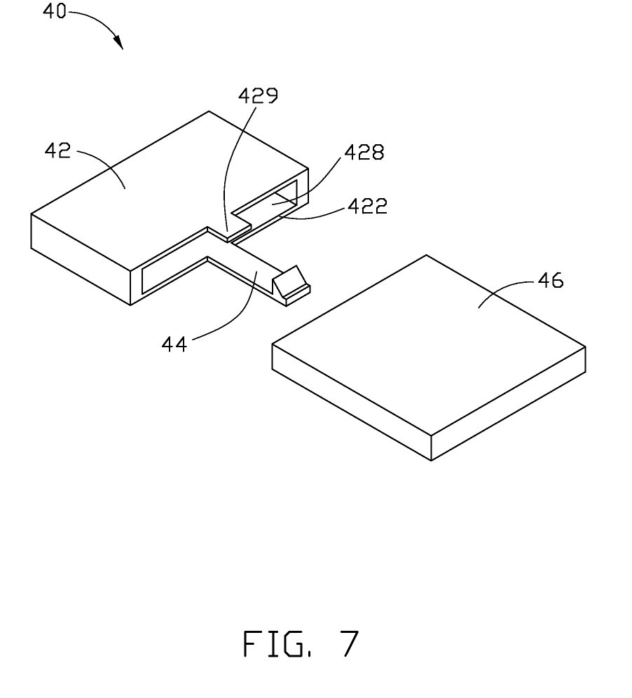

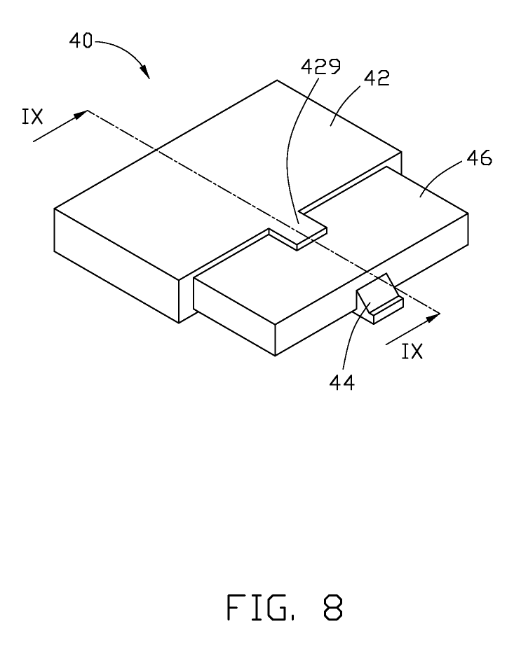

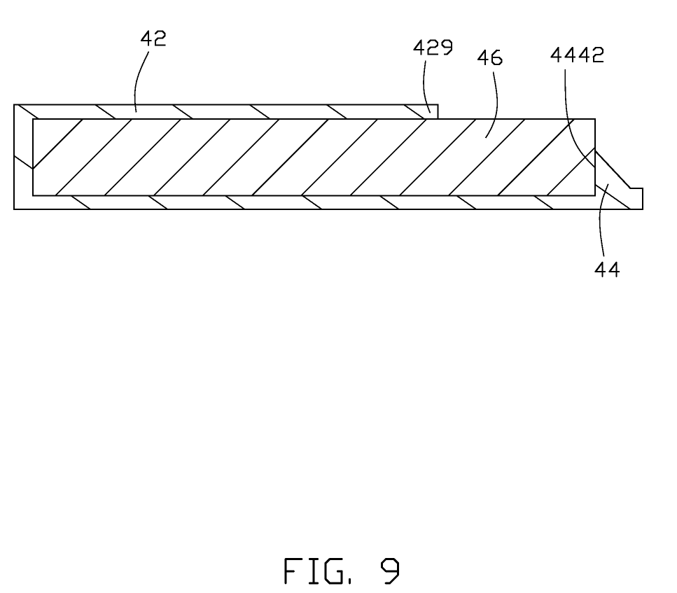

Referring to FIGS. 7 through 9, a third embodiment of a battery fixing mechanism 40 is similar to the first embodiment of the battery fixing mechanism 20, except that the battery fixing mechanism 40 also has a resisting piece 429 formed on a side surface 422 of a main body 42. The resisting piece 429 is opposite to the elastic positioning member 44. The main body 42 defines an assembling groove 428 in the side surface 422 between the elastic positioning member 44 and the resisting piece 429. When a battery 46 is received in the assembling groove 428 of the main body 42, the elastic positioning member 44 and the resisting piece 429 resist opposite surfaces of the battery 46.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A battery fixing mechanism, comprising:
a main body defining an assembling groove configured to partly receive at least one battery;
at least one elastic positioning member extending from the main body;
wherein the at least one elastic positioning member comprises a restricting portion, the restricting portion faces the assembling groove; the at least one elastic positioning member is capable of bending so that the at least one battery can be inserted into the assembling groove of the main body.

2. The battery fixing mechanism of claim 1, wherein the at least one elastic positioning member further comprises an elastic portion extending from the main body; the restricting portion extends substantially perpendicularly from an end of the elastic portion away from the main body.

3. The battery fixing mechanism of claim 2, wherein the elastic portion is made of metal or plastic.

4. The battery fixing mechanism of claim 2, wherein the at least one elastic positioning member further comprises an operating portion formed on an end of the restricting portion away from the elastic portion.

5. The battery fixing mechanism of claim 1, wherein the at least one elastic positioning member comprises one elastic positioning member extending from the main body.

6. The battery fixing mechanism of claim 1, wherein the at least one elastic positioning member comprises two elastic positioning members extending from the main body, and each elastic positioning member is opposite to each other.

7. The battery fixing mechanism of claim 1, wherein the at least one elastic positioning member has a resisting surface corresponding to a shape of the battery.

8. The battery fixing mechanism of claim 7, wherein the resisting surface is an arched surface.

9. The battery fixing mechanism of claim 1, wherein the main body is rectangular shaped.

10. A battery fixing mechanism, comprising:
a main body;
an elastic positioning member extending from an end of the main body; and
a resisting piece extending from the end of the main body, opposite to the elastic positioning member;
wherein the main body defines an assembling groove between the elastic positioning member and the resisting piece; the elastic positioning member comprises a restricting portion opposite to the assembling groove; the elastic positioning member is capable of bending so that a battery can be inserted into the assembling groove of the main body.

11. The battery fixing mechanism of claim 10, wherein the elastic positioning member has a resisting surface corresponding to a shape of the battery.

12. The battery fixing mechanism of claim 11, wherein the resisting surface is an arched surface.

13. The battery fixing mechanism of claim 10, wherein the elastic positioning member further comprises an elastic portion extending from the main body; the restricting portion extends substantially perpendicularly from an end of the elastic portion away from the main body.

14. The battery fixing mechanism of claim 13, wherein the elastic portion is made of metal or plastic.

15. The battery fixing mechanism of claim 14, wherein the elastic positioning member further comprises an operating portion formed on an end of the restricting portion away from the elastic portion.
